(19) United States
(12) Patent Application Publication
(10) Pub. No.: US 2009/0307401 A1
(43) Pub. Date: Dec. 10, 2009

(54) CIRCUIT AND METHOD FOR BRIDGING MULTIPLE SOURCE AHB SLAVES TO A TARGET AHB SLAVE

(75) Inventor: Cunrong Feng, Shanghai (CN)

Correspondence Address: Docket Clerk, P.O. Box 802432, Dallas, TX, 75380, US

(73) Assignee: ST Wireless SA, Plan-les-Ouates (CH)

(21) Appl. No.: 12/473,835

(22) Filed: May 28, 2009

Related U.S. Application Data
(60) Provisional application No. 61/057,361, filed on May 30, 2008.

(51) Int. Cl. G06F 13/00

(52) U.S. Cl. 710/110

(57) ABSTRACT

A circuit and method for bridging multiple source Advanced High-performance Bus (AHB) slaves to a target AHB slave are provided. The circuit uses multiple slave controllers and a multiplexing device to handle signals between the multiple source AHB slaves and the target AHB slave to avoid conflicts between the multiple source AHB slaves to access the target AHB slave.

### CROSS-REFERENCE TO RELATED APPLICATION(S) AND CLAIM OF PRIORITY

This application claims priority under 35 U.S.C. §119(e) to U.S. Provisional Patent Application No. 61/057,361 filed on May 30, 2008 and entitled “CIRCUIT AND METHOD OF BRIDGING MULTIPLE SOURCE AHB SLAVES TO TARGET AHB SLAVE,” which is hereby incorporated by reference.

### TECHNICAL FIELD

This disclosure relates generally to advanced high-performance buses and, more specifically, to a circuit and method for bridging advanced high-performance buses from multiple sources to a target.

### BACKGROUND

Advanced High-performance Bus (AHB) is a bus protocol provided by ARM Limited. The AHB protocol includes the following features:
burst transfers;
split transactions;
single cycle bus master handover;
single clock edge operation;
non-tristate implementation; and
wider data bus configurations (64/128 bits).
   The AHB protocol defines AHB masters and AHB slaves, as well as signals used between the masters and/or slaves.

Some critical designs (such as an External Memory Interface) have been developed to support only one AHB slave interface. However, with the increment of parallelity in current system-on-a-chip (SOC) systems, such designs need to support multiple AHB slave interfaces so that different sub-systems can be coupled only when necessary. As an example, different sub-systems may need to connect to a common External Bus Interface (EBI).

A circuit and method for bridging multiple source AHB slaves to a target AHB slave are provided.

In a first embodiment, an AHB multi-slave bridging circuit includes a first slave controller configured to be coupled to a first source AHB slave. The first slave controller is configured to generate first output AHB signals for a target AHB slave in response to received first input AHB signals from the first source AHB slave. The AHB multi-slave bridging circuit also includes a second slave controller configured to be coupled to a second source AHB slave. The second slave controller is configured to generate second output AHB signals for the target AHB slave in response to received second input AHB signals from the second source AHB slave. In addition, the AHB multi-slave bridging circuit includes a multiplexing device coupled to the first and second slave controllers and configured to be coupled to the target AHB slave. The multiplexing device is configured to selectively transmit the first and second output AHB signals to the target AHB slave to avoid conflicts between the first and second source AHB slaves to access the target AHB slave.

In a second embodiment, the AHB multi-slave bridging circuit also includes a priority arbiter coupled to the multiplexing device. The priority arbiter is configured to transmit a control signal to the multiplexing device to instruct the multiplexing device to transmit either one of the output AHB signals from the first slave controller or one of the output AHB signals from the second slave controller to the target AHB slave.

In a third embodiment, a method of bridging multiple source AHB slaves to a target AHB slave includes generating first output AHB signals for the target AHB slave in response to received first input AHB signals from a first source AHB slave. The method also includes generating second output AHB signals for the target AHB slave in response to received second input AHB signals from a second source AHB slave. The method further includes selectively transmitting the first and second output AHB signals to the target AHB slave to avoid conflicts between the first and second source AHB slaves to access the target AHB slave.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “include” and “comprise,” as well as derivatives thereof, mean inclusion without limitation. The term “or,” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates an example AHB multi-slave bridging circuit according to this disclosure;

FIG. 2 illustrates an example slave controller and example input and output signals to the slave controller according to this disclosure;

FIG. 3 illustrates an example state diagram of the slave controller according to this disclosure;

FIG. 4 illustrates an example priority arbiter according to this disclosure; and

FIG. 5 illustrates an example process flow diagram for bridging multiple source AHB slaves to a target AHB slave according to this disclosure.

### DETAILED DESCRIPTION

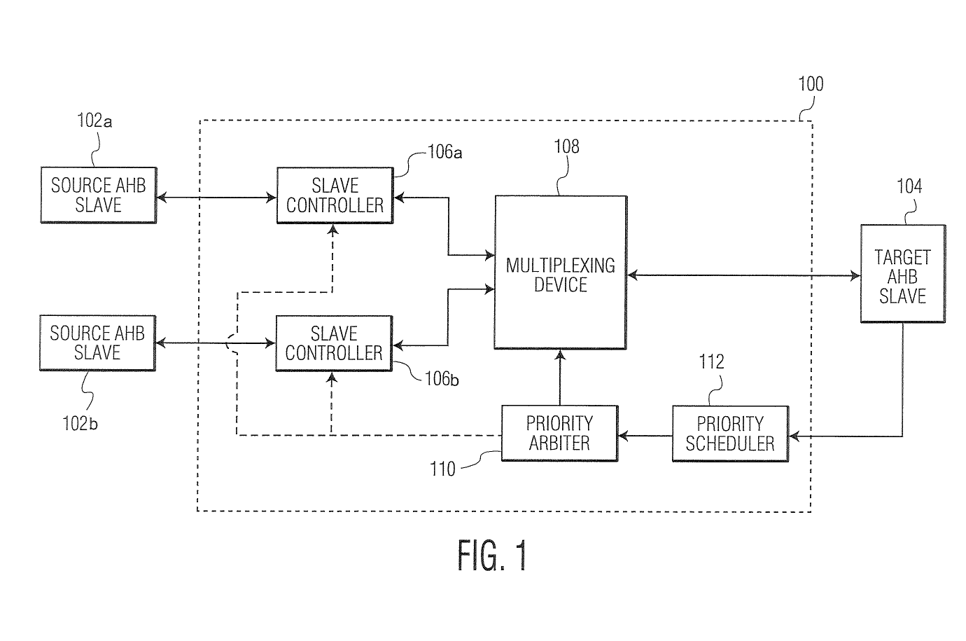

FIGS. 1 through 5, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example Advanced High-performance Bus (AHB) multi-slave bridging circuit 100 according to this disclosure. The embodiment of the AHB multi-slave bridging circuit 100 shown in FIG. 1 is for illustration only. Other embodiments could be used without departing from the scope of this disclosure.

The AHB multi-slave bridging circuit 100 allows multiple source AHB slaves 102a and 102b to communicate with a target AHB slave 104. In this embodiment, the AHB multi-slave bridging circuit 100 is configured to bridge two source AHB slaves and a single target AHB slave. As an example, the source AHB slaves 102a and 102b may be a system control External Bus Interface (EBI) and an image sub-system EBI, respectively. Additionally, the target AHB slave 104 may be an EBI slave interface. However, in other embodiments, the AHB multi-slave bridging circuit 100 is configured to support more than two source AHB slaves for the target AHB slave 104.

The AHB multi-slave bridging circuit 100 includes slave controllers 106a and 106b, a multiplexing device 108, a priority arbiter 110, and a priority scheduler 112. In general, the slave controller 106a operates to generate output AHB signals to drive the target AHB slave 104 in response to input AHB signals from the source AHB slave 102a. Similarly, the slave controller 106b operates to generate output AHB signals to drive the target AHB slave 104 in response to input AHB signals from the source AHB slave 102b. The output AHB signals from the slave controllers 106a and 106b are transmitted to the multiplexing device 108, which selectively transmits the output AHB signals from the slave controllers 106a and 106b to the target AHB slave 104. The prioritization of various signals being handled by the AHB multi-slave bridging circuit 100 is controlled by the priority arbiter 110. The priority arbiter 110 is at least partly controlled by the priority scheduler 112.

These components of the AHB multi-slave bridging circuit 100 also operate to transmit input AHB signals from the target AHB slave 104 to the source AHB slave 102a and/or the source AHB slave 102b, depending on the desired destination of the input AHB signals from the target AHB slave 104. In the following examples, the components of the AHB multi-slave bridging circuit 100 are first described with respect to signals being transmitted from the source AHB slaves 102a and 102b to the target AHB slave 104.

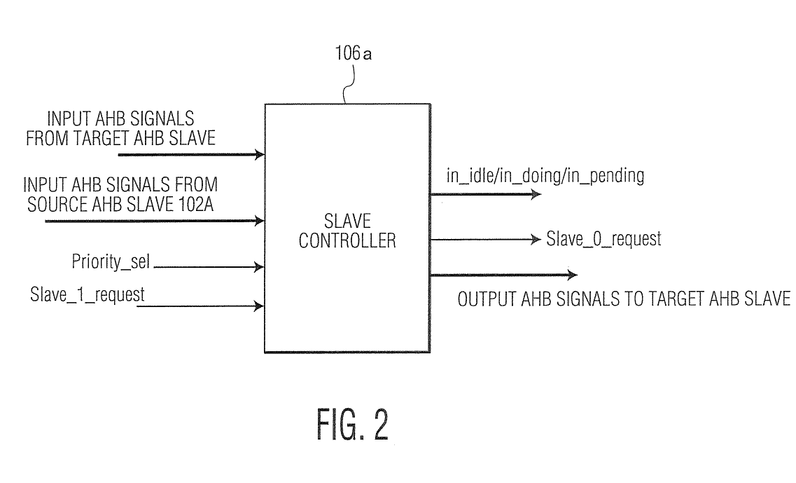

FIG. 2 illustrates an example slave controller 106a and example input and output signals to the slave controller 106a according to this disclosure. The embodiment of the slave controller 106a shown in FIG. 2 is for illustration only. Other embodiments could be used without departing from the scope of this disclosure.

As shown in FIG. 2, input signals to the slave controller 106a and output signals from the slave controller 106a are identified. The slave controller 106b can include a similar configuration and similar functions as the slave controller 106a. As used here, any signal with a “0” is associated with the source AHB slave 102a, while any signal with a “1” is associated with the source AHB slave 102b.

The slave controller 106a receives input AHB signals from the target AHB slave 104, input AHB signals from the source AHB slave 102a, a priority select signal, and a slave_1_request signal. The input AHB signals from the target AHB slave 104 include HREADY_out, HRESP, and HRDATA signals. The input AHB signals from the source AHB slave 102a include HADDR, HCLK, HRESETn, HPROT, HTRANS, HBURST, HTRANS, HSEL, HREADY_in, and HWDATA signals. The slave controller 106a outputs a state signal, a slave_0_request signal, and output AHB signals for driving the target AHB slave 104. The state signal can be an in_idle signal, an in_doing signal, or an in_pending signal. The in_idle signal can be used as a condition to drive the HREADY_in signal of the target AHB slave 104. The in_doing and in_pending signals can be used for debugging. The slave_0_request signal includes the following conditions: HTRANS==NOSEQ/SEQ, HSEL==1 and HREADY==1, where HREADY is from the source AHB slave 102a. The output AHB signals to the target AHB source 104 include HPROT, HADDR, HWRITE, HBURST, HWDATA, and HSEL signals.

The slave controller 106a operates to output appropriate AHB signals for the target AHB slave 104. For example, if an input signal from the source AHB slave is HTRANS==SEQUENTIAL and this source AHB slave is going to be blocked due to its low priority or because another source slave's burst transfer is not completed, then the HTRANS will be turned or modified into “NONSEQUENTIAL” in order to meet the requirements of the AHB protocol. As another example, an HBURST signal from the source AHB slave 102a will be turned into an INCR signal in order to meet the requirements of the AHB protocol.

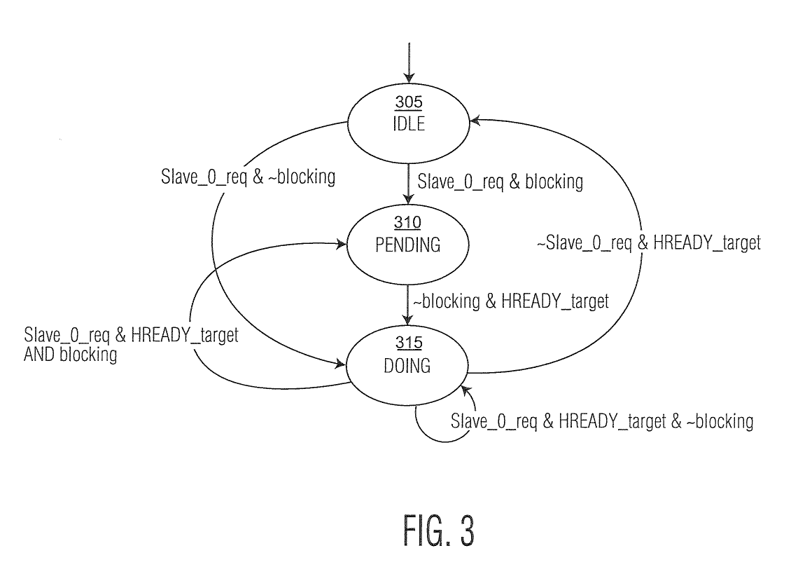

The slave controller 106a also operates to manage the output timing of the output AHB signals based on priority, an HREADY signal from the target AHB slave 104, and a valid current request signal from the source AHB slave 102a. The operation of the slave controller 106 is described with reference to a state diagram of FIG. 3.

FIG. 3 illustrates an example state diagram of the slave controller 106a according to this disclosure. The embodiment of the state diagram shown in FIG. 3 is for illustration only. Other embodiments could be used without departing from the scope of this disclosure.

In this example embodiment, the slave controller 106a has three states: an IDLE state 305, a PENDING state 310, and a DOING state 315. The initial state of the slave controller 106a is the IDLE state 305. From the IDLE state 305, in the event that there is a valid current request signal from the source AHB slave 102a (i.e., current input AHB signals from the source AHB slave 102a indicate a valid AHB access) and there is no “blocking”, then the state of the slave controller is switched to the DOING state 315. The term “blocking” means that priority is low and that there is at least one other active request from the source AHB slave 102b. However, from the IDLE state 305, in the event that there is a valid current request signal from the source AHB slave 102a and there is “blocking”, then the state of the slave controller 106a is switched to the PENDING state 310. From the PENDING state 310, if there is no “blocking” and an HREADY signal from the target AHB slave 104 (indicated as HREADY_target in FIG. 3) is “1”, then the state of the slave controller 106a is switched to the DOING state 315 to process the current request signal. From the DOING state 315, in the event that there is no valid current request signal from the source AHB slave 102a and the HREADY signal from the target AHB slave 104 is “1”, then the state of the slave controller 106a is switched to the IDLE state 305. From the DOING state 315, if there is another valid current request signal from the source AHB slave 102a and the HREADY signal is “1” from the target AHB slave and there is “blocking”, then the state of the slave controller 106a is switched to the PENDING state 310. However, if there is another valid current request signal from the source AHB slave 102a and the HREADY signal from the target AHB slave 104 is “1” and there is no “blocking”, then the state of the slave controller 106a remains at the DOING state 315 to process this next request signal.

Returning to FIG. 1, the processed request signals from the slave controller 106a are transmitted to the multiplexing device 108. Similarly, the processed request signals from the other slave controller 106b are also transmitted to the multiplexing device 108. The multiplexing device 108 operates to selectively transmit the received request signals to the target AHB slave 104 based on at least one output signal from the priority arbiter 110 and the target AHB slave 104 to avoid conflicts with respect to transmission of signals to the target AHB slave 104. For an HREADY signal from one or both of the source AHB slaves 102a and 102b, the multiplexing device 108 drives the HREADY input signal to the target AHB slave 104 to be “1”, as long as the HREADY output signal from the target AHB slave 104 is “1” or HIGH. In the event that all in_idle state signals from different source AHB slaves are “1” and one of the input HREADY signals from different source AHB slaves is “1”, the HREADY input signal to the target AHB slave 104 is set to “1” as well; otherwise, it remains “0”. The HWDATA signals to the target AHB slave 104 are equal to HWDATA signals from the source slave controller 102a or HWDATA signals from the source slave controller 102b because the source slave controller 102a or 102b drives its HWDATA signals to be full zero when its internal state is not in the in_doing state. For HPROT, HSEL, HTRANS, HBURST, and HADDR signals from the slave controllers 102a and 102b to the target AHB slave 104, the multiplexing device 108 selectively outputs the appropriate signal from one of the slave controllers 106a and 106b based on a control signal (referred to herein as an ahb_mux signal) from the priority arbiter 110. If the ahb_mux signal indicates that the signal from the slave controller 106a should be transmitted, then the multiplexing device 108 selectively transmits the signal from the slave controller 106a. If the ahb_mux signal indicates that the signal from the slave controller 106b should be transmitted, then the multiplexing device 108 selectively transmits the signal from the slave controller 106b.

The priority arbiter 110 operates to generate priority select signals for the slave controllers 106a and 106b and ahb_mux signals for the multiplexing device 108. A priority select signal indicates which priority is higher between the source AHB slave 102a and the source AHB slave 102b. The priority select signal can be set by an external module (not shown) based on system requirements or automatically generated by a bandwidth allocation method (e.g., round-robin or a shifter as the priority scheduler 112). An ahb_mux signal indicates whether a signal (e.g., an HADDR, HPROT, HTRANS, or HBURST signal) from the slave controller 106a or a signal (e.g., an HADDR, HPROT, HTRANS, or HBURST signal) from the slave controller 106b should be transmitted by the multiplexing device 108 to the target AHB slave 104. When only one of the source AHB slaves 102a and 102b is active (i.e., there is only a request signal from one of the slave controllers 106a and 106b), then the ahb_mux signal produced by the priority arbiter 110 will indicate that the signal from the slave controller associated with the active source AHB slave should be transmitted by the multiplexing device 108. However, if both source AHB slaves 102a and 102b are active, then an arbit_sel signal that is received by the priority arbiter 110 will determine which signal should be transmitted. An arbit_sel signal is an external priority bit from an external priority arbiter, an external bandwidth allocation module (not shown), or the priority arbiter 110.

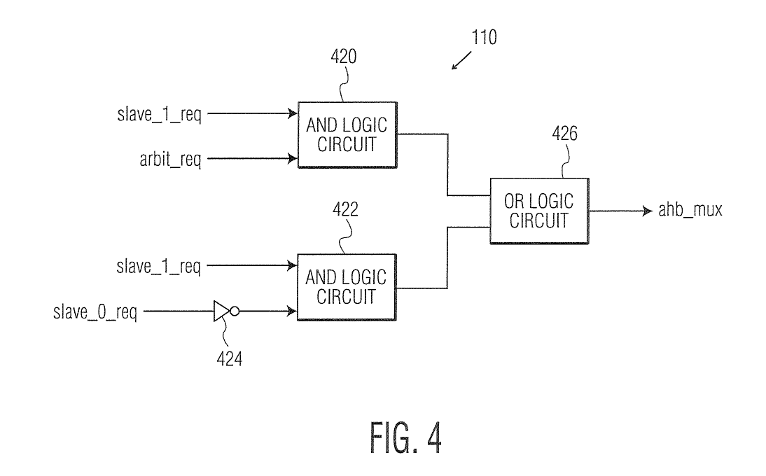

FIG. 4 illustrates an example priority arbiter 110 according to this disclosure. The embodiment of the priority arbiter 110 shown in FIG. 4 is for illustration only. Other embodiments could be used without departing from the scope of this disclosure.

In this example embodiment, the priority arbiter 110 utilizes two AND logic circuits 420 and 422, an inverter 424, and an OR logic circuit 426 to produce ahb_mux signals. In this embodiment, the AND logic circuit 422 receives a slave_1_request signal from the slave controller 106b and an inverted version of a slave_0_request signal from the slave controller 106a via the inverter 424. The output of the AND logic circuit 422 is applied to an input of the OR logic circuit 426. Thus, when the slave_1_request signal is active (e.g., high) and the slave_0_request signal is inactive (e.g., low), then the ahb mux signal will indicate that the signal from the slave controller 102b should be transmitted by the multiplexing device 108 (e.g., the ahb mux signal will be high). The other AND logic circuit 420 receives a slave_1_request signal from the slave controller 106b and an arbit_sel signal. The output of the AND logic circuit 420 is applied to the other input of the OR logic circuit 426. Thus, when the slave_1_request signal is active (e.g., high) and the arbit_sel signal indicates the source AHB slave 102b (e.g., high), then the ahb_mux signal will indicate that the signal from the slave controller 106b should be transmitted by the multiplexing device 108 (e.g., the ahb_mux signal will be high). Otherwise, the ahb_mux signal will indicate that the signal from the slave controller 106a should be transmitted by the multiplexing device 108 (e.g., the ahb_mux signal will be low).

Returning to FIG. 1, the priority scheduler 112 is configured to generate a priority signal to allocate the bandwidth between both source AHB slaves 102a and 102b. The priority signal is used to generate the arbit_sel signal. In some embodiments, the priority scheduler 112 is a bit shifter (e.g., a 32-bit shifter) that receives a shift enable bit from the target AHB slave 104 when the target AHB slave 104 detects that a valid access to the target AHB slave 104 is finished. In some embodiments, the completion of a valid access is detected via two steps: (1) in one AHB cycle, HTRANS==NOSEQ and the input HREADY signal of the target AHB slave 104 is “1”, if burst keep is enabled; and (2) in consequent AHB cycles, once the output HREADY signal of the target AHB slave is “1”. However, if burst keep is not enabled, then the completion of a valid access is detected via two steps: (1) in one AHB cycle, HTRANS==NOSEQ or HTRANS==SEQ and the input HREADY signal of the target AHB slave is “1”, and (2) in consequent AHB cycles, once the output HREADY signal of the target AHB slave is “1”. Although the priority scheduler 112 is illustrated in FIG. 1 as being part of the AHB multi-slave bridging circuit 100, in other embodiments, the priority scheduler 112 may be external to the AHB multi-slave bridging circuit.

The manner in which signals (e.g., HREADY, HRDATA, and HRESP signals) from the target AHB slave 104 to the source AHB slaves 102a and 102b are handled by the AHB multi-slave bridging circuit 100 is now described. An input AHB signal from the target AHB slave 104 to a particular source AHB slave (e.g., the source AHB slave 102a) is transmitted to the multiplexing device 108 that transmits the signal to one of the slave controllers 106a or 106b associated with the particular source AHB device. For example, the signal can be transmitted from the multiplexing device 108 to the slave controller 106a that is associated with the source AHB device 102a. At the slave controller 106a, the signal is either transmitted to the source AHB slave 102a, or an appropriate output AHB signal is generated by the slave controller 106a and transmitted to the source AHB slave 102a.

As an example, with reference to FIG. 3, when an HREADY signal is received from the target AHB slave 104 at the slave controller 106a, the slave controller 106a outputs an appropriate HREADY signal depending on the current state of the slave controller 106a. If the slave controller 106a is in the IDLE state 305, then the output HREADY signal is HREADY==1. If the slave controller 106a is in the PENDING state 310, then the output HREADY signal is HREADY==0, which makes the source AHB slave 102a wait. However, if the slave controller 106a is in the DOING state 315, then the output HREADY signal is the HREADY signal from the target AHB slave 104.

Similarly, when an HRESP signal is received from the target AHB slave 104 at the slave controller 106a, the slave controller 106a outputs an appropriate HRESP signal depending on the current state of the slave controller 106a. If the slave controller 106a is in the IDLE state 305 or PENDING state 310, then the output HRESP signal is HRESP==0. However, if the slave controller 106a is in the DOING state 315, then the output HRESP signal is the HRESP signal from the target AHB slave 104.

For the HRDATA signal from the target AHB slave 104, the slave controller 106a outputs the same HRDATA signal from the target AHB slave to the source AHB slave 102a. The other slave controller 106b operates in a similar manner to transmit the signal from the target AHB slave 104 to the source AHB slave 102b or to generate and transmit an appropriate AHB signal to the source AHB slave 102b in response to an input AHB signal from the target AHB slave.

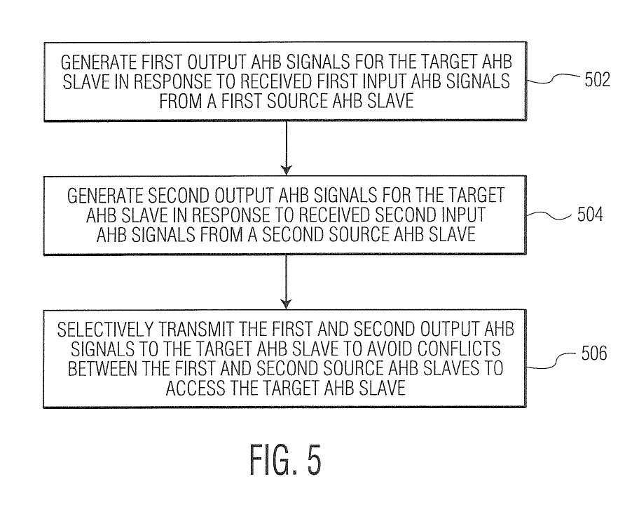

FIG. 5 illustrates an example process flow diagram for bridging multiple source AHB slaves to a target AHB slave according to this disclosure. The embodiment of the process shown in FIGURE 5 is for illustration only. Other embodiments could be used without departing from the scope of this disclosure.

In step 502, first output AHB signals for the target AHB slave are generated in response to received first input AHB signals from a first source AHB slave. At step 504, second output AHB signals for the target AHB slave are generated in response to received second input AHB signals from a second source AHB slave. At step 506, the first and second output AHB signals are selectively transmitted to the target AHB slave to avoid conflicts between the first and second source AHB slaves to access the target AHB slave.

Although FIGS. 1 through 5 have illustrated various details of an example AHB multi-slave bridging circuit 100 (and its components and operations) and details of an example process, various changes may be made to FIGS. 1 through 5. For example, in FIG. 1, the AHB multi-slave bridging circuit 100 could be coupled to any number of source AHB slaves and to any number of target AHB slaves, and the functional division shown in FIG. 1 is for illustration only. Various components in FIG. 1 could be combined, further subdivided, or omitted and additional components could be added according to particular needs. Also, while the operations of the method illustrated in FIG. 5 are shown and described in a particular order, the order of the operations of the method may be altered so that certain operations may be performed in an inverse order or so that certain operations may be performed, at least in part, concurrently with other operations. In yet other embodiments, instructions or sub-operations of distinct operations may be implemented in an intermittent and/or alternating manner

Although this disclosure has described example embodiments of the present invention, various changes and modifications may be suggested to one skilled in the art. It is intended that this disclosure encompass such changes and modifications as fall within the scope of the appended claims.

What is claimed is:

1. An Advanced High-performance Bus (AHB) multi-slave bridging circuit, the AHB multi-slave bridging circuit comprising:
a first slave controller configured to be coupled to a first source AHB slave, the first slave controller configured to generate first output AHB signals for a target AHB slave in response to received first input AHB signals from the first source AHB slave;
a second slave controller configured to be coupled to a second source AHB slave, the second slave controller configured to generate second output AHB signals for the target AHB slave in response to received second input AHB signals from the second source AHB slave; and
a multiplexing device coupled to the first and second slave controllers and configured to be coupled to the target AHB slave, the multiplexing device configured to selectively transmit the first and second output AHB signals to the target AHB slave to avoid conflicts between the first and second source AHB slaves to access the target AHB slave.

2. The circuit as set forth in claim 1, wherein the target AHB slave includes an External Bus Interface slave interface.

3. The circuit as set forth in claim 2, wherein at least one of the first and second source AHB slaves includes a system control External Bus Interface.

4. The circuit as set forth in claim 2, wherein at least one of the first and second source AHB slaves includes an image sub-system External Bus Interface.

5. The circuit as set forth in claim 1, wherein the first slave controller is configured to process the input AHB signals from the first source AHB slave based at least on an HREADY signal from the target AHB slave.

6. The circuit as set forth in claim 1, wherein the first slave controller is configured to modify an HREADY signal from the target AHB slave based on a current state of the first slave controller, the current state being one of a plurality of finite states of the first slave controller.

7. The circuit as set forth in claim 1, wherein the first slave controller is configured to modify an HRESP signal from the target AHB slave based on a current state of the first slave controller, the current state being one of a plurality of finite states of the first slave controller.

8. The circuit as set forth in claim 1, further comprising:
a priority arbiter coupled to the multiplexing device, the priority arbiter configured to transmit a control signal to the multiplexing device to instruct the multiplexing device to transmit either one of the output AHB signals from the first slave controller or one of the output AHB signals from the second slave controller to the target AHB slave.

9. A method of bridging multiple source Advanced High-performance Bus (AHB) slaves to a target AHB slave, the method comprising:
generating first output AHB signals for the target AHB slave in response to received first input AHB signals from a first source AHB slave;
generating second output AHB signals for the target AHB slave in response to received second input AHB signals from a second source AHB slave; and
selectively transmitting the first and second output AHB signals to the target AHB slave to avoid conflicts between the first and second source AHB slaves to access the target AHB slave.

10. The method as set forth in claim 9, wherein the target AHB slave includes an External Bus Interface slave interface.

11. The method as set forth in claim 10, wherein at least one of the first and second source AHB slaves includes a system control External Bus Interface.

12. The method as set forth in claim 10, wherein at least one of the first and second source AHB slaves includes an image sub-system External Bus Interface.

13. The method as set forth in claim 9, wherein generating the first output AHB signals includes processing the input AHB signals from the first source AHB slave based at least on an HREADY signal from the target AHB slave.

14. The method as set forth in claim 9, further comprising:
modifying an HREADY signal from the target AHB slave based on a current state for processing signals associated with the first source AHB slave, the current state being one of a plurality of finite states.

15. The method as set forth in claim 9, further comprising:
modifying an HRESP signal from the target AHB slave based on a current state for processing signals associated with the first source AHB slave, the current state being one of a plurality of finite states.

16. An Advanced High-performance Bus (AHB) multi-slave bridging circuit, the AHB multi-slave bridging circuit comprising:
a first slave controller configured to be coupled to a first source AHB slave, the first slave controller configured to generate first output AHB signals for a target AHB slave in response to received first input AHB signals from the first source AHB slave;
a second slave controller configured to be coupled to a second source AHB slave, the second slave controller configured to generate second output AHB signals for the target AHB slave in response to received second input AHB signals from the second source AHB slave;
a multiplexing device coupled to the first and second slave controllers and configured to be coupled to the target AHB slave, the multiplexing device configured to selectively transmit the first and second output AHB signals to the target AHB slave to avoid conflicts between the first and second source AHB slaves to access the target AHB slave; and
a priority arbiter coupled to the multiplexing device, the priority arbiter configured to transmit a control signal to the multiplexing device to instruct the multiplexing device to transmit either one of the output AHB signals from the first slave controller or one of the output AHB signals from the second slave controller to the target AHB slave.

17. The circuit as set forth in claim 16, wherein the target AHB slave includes an External Bus Interface slave interface.

18. The circuit as set forth in claim 17, wherein at least one of the first and second source AHB slaves includes a system control External Bus Interface.

19. The circuit as set forth in claim 17, wherein at least one of the first and second source AHB slaves includes an image sub-system External Bus Interface.

20. The circuit as set forth in claim 16, wherein the first slave controller is further configured to modify at least one of an HREADY signal and an HRESP signal from the target AHB slave based on a current state of the first slave controller, wherein the current state is one of a plurality of finite states of the first slave controller.
